(19) United States
(12) Patent Application Publication
(10) Pub. No.: US 2024/0367781 A1
(43) Pub. Date: Nov. 7, 2024

(54) AIRCRAFT WHEEL AND BRAKE ASSEMBLY

(71) Applicant: Boom Technology, Inc., Centennial, CO (US)

(72) Inventor: David Patrick Pels, Aurora, CO (US)

(21) Appl. No.: 18/310,274

(22) Filed: May 1, 2023

(51) Int. Cl. B64C 25/42; B60B 21/00; B60B 27/00; B64C 25/36; F16D 55/36; F16D 65/00; F16D 65/847

(52) U.S. Cl. CPC B64C 25/42; B60B 21/00; B60B 27/0052; B64C 25/36; F16D 55/36; F16D 65/0056; F16D 65/847; B60B 2380/70; B60B 2900/513; B60B 2900/541; F16D 2055/0008

(57) ABSTRACT

An aircraft wheel and brake system includes a wheel assembly mounted on an axle portion of landing gear of an aircraft. The aircraft wheel and brake assembly may include a brake assembly installed within an interior space defined by the axle portion of the landing gear. The brake assembly may occupy substantially all of an interior installation volume defined by the axle portion, thus increasing a brake mass that can be accommodated by a given axle/wheel size/configuration. The brake assembly may be accessible at an open outboard side of the axle portion, allowing for removal and replacement of the brake assembly without removal of the wheel assembly from the axle portion of the landing gear and/or lifting of the aircraft to facilitate removal of the wheel assembly. The wheel assembly may include a tire mounted on a rim assembly including multiple rim portions coupled by an interior fastening ring.

### TECHNICAL FIELD

This description relates, in general, wheel and brake assemblies, and in particular to aircraft wheel and brake assemblies.

### BACKGROUND

Aircraft typically include a braking system to provide for deceleration of the aircraft after landing and during a rejected take-off (RTO). In these conditions the aircraft is typically moving at a relatively high speed, the braking system may be employed to sufficiently reduce the speed of the aircraft so that the aircraft does not exceed the length of the runway, and so that the aircraft can safely exit the runway. In terms of energy, an aircraft braking system typically converts kinetic energy of the aircraft (1/2 mv²) into heat energy. To accomplish this safely, aircraft may use brake rotors and stators to absorb this energy in the form of heat. In order to absorb this energy, the aircraft braking system typically ensures the amount of brake material (for example, carbon and/or steel) is sufficient to absorb the stopping energy, to prevent melting of the rotors and/or stators, which may adversely impact effective deceleration and/or stopping of the aircraft. As aircraft size and/or weight increases take-off speeds and landing speeds typically also increase. As a result, the braking energy to be absorbed in stopping the aircraft also increases. In some examples, increased braking energy may be provided by increasing a volume of the braking system. However, as the braking system is often incorporated into one or more wheel assemblies of the landing gear of the aircraft, an increased volume of the braking system drives a corresponding increase in the size of the wheel assemblies and/or a size of the landing gear carrying the wheel assemblies. The increased volume of the braking system and corresponding increased size of the wheel assemblies and/or landing gear may result in unacceptable size such that the landing gear no longer fit within the aircraft gear wells and/or weight penalties that may adversely impact operational efficiency of the aircraft. This adverse impact may be exacerbated in an aircraft designed for supersonic operation, as these types of weight and/or drag penalties may be amplified during supersonic cruise operation of the aircraft.

### SUMMARY

Systems and methods, in accordance with implementations described herein, provide a wheel assembly and brake assembly for an aircraft. In some examples, the brake assembly is incorporated into a hub portion of the wheel assembly. In some examples, an outer diameter of the brake assembly corresponds to an inner diameter of the hub portion of the wheel assembly. In some examples, an axial dimension of the brake assembly corresponds to an axial dimension of the hub portion of the wheel assembly. In some examples, the brake assembly may occupy substantially all of a volume defined by the hub portion of the wheel assembly. In some examples, this may provide for an increased brake mass, or braking energy, for a given size and/or configuration of a particular wheel assembly. In some examples, the brake assembly is accessible from an outer facing side portion of the wheel assembly installed on the landing gear of the aircraft, providing for removal and/or replacement of the brake assembly from the wheel assembly. In some examples, accessibility to the brake assembly from the outer facing side portion of the wheel assembly provides for removal and/or replacement of the brake assembly without removal of the wheel assembly from the landing gear.

### BRIEF DESCRIPTION OF THE DRAWINGS

FIG. 1A is a perspective view of an example aircraft.

FIG. 1B illustrates example features of a wheel and brake assembly of example landing gear of the example aircraft shown in FIG. 1A.

FIG. 2A is a side perspective view of an example aircraft wheel and brake assembly.

FIG. 2B is a top perspective view of the example aircraft wheel and brake assembly shown in FIG. 2A.

FIG. 2C is a perspective view of an example bogie of the example aircraft wheel and brake assembly shown in FIGS. 2A and 2B.

FIG. 2D is a partial cutaway view of the example bogie shown in FIG. 2C.

FIGS. 3A and 3B are partial cross-sectional views, taken along line A-A of FIG. 2A, illustrating an example brake assembly installed in an example wheel assembly of the example aircraft wheel and brake assembly shown in FIGS. 2A and 2B.

FIG. 3D is a perspective view of an example carrier of the example brake assembly shown in FIGS. 3A and 3B.

FIG. 3D is a perspective view of an example rotor and stator assembly mounted on the example carrier shown in FIG. 3C.

FIGS. 4A-4D illustrate an example process of removing an example brake assembly from an example wheel and brake assembly.

FIG. 5A is a perspective view of an outboard side of an aircraft wheel and brake assembly.

FIG. 5B is a perspective view of an outboard side of an aircraft wheel and

brake assembly including an example cooling hub.

FIG. 5C is a perspective view of an inboard side of an aircraft wheel and

brake assembly.

FIG. 5D is a partial cross-sectional view illustrating an air flow path through an example aircraft wheel and brake assembly.

FIGS. 6A-6D illustrate an example torque attenuation system couplable to an aircraft wheel and brake assembly.

FIG. 7A is a perspective view of an example wheel assembly.

FIG. 7B is a cross-sectional view taken along line G-G of FIG. 7A.

FIG. 7C is a close-in view of an area H shown in FIG. 7B.

FIG. 7D is a close-in view of an area J shown in FIG. 7C.

FIG. 7E is a perspective view of an example fastening ring of the example wheel assembly shown in FIGS. 7A-7D.

FIGS. 8A-8E illustrate an example process of mounting an example wheel assembly on an example axle.

The above figures are provided to illustrate features and concepts to be described herein, and are not necessarily drawn to scale.

### DETAILED DESCRIPTION

Systems and methods, in accordance with implementations described herein, will be described with respect to incorporation of a brake assembly into a wheel assembly coupled to the landing gear of an aircraft. Systems and methods, in accordance with implementations described herein, may be applied to aircraft designed to operate at both subsonic and supersonic speeds, and/or to aircraft designed to operate at subsonic speeds. The braking system may be employed to reduce the speed of the aircraft upon landing, to provide for safe operation of the aircraft after landing. As aircraft size and/or weight and/or operational speed increases, increased braking force may be required to decelerate and/or stop the aircraft the aircraft upon landing. A braking system, in accordance with implementations described herein, may provide for increased braking energy within a given installation volume, thus avoiding the need to increase a size and/or a weight of the braking system to provide for an increased braking energy, and avoiding associated weight and/or drag penalties.

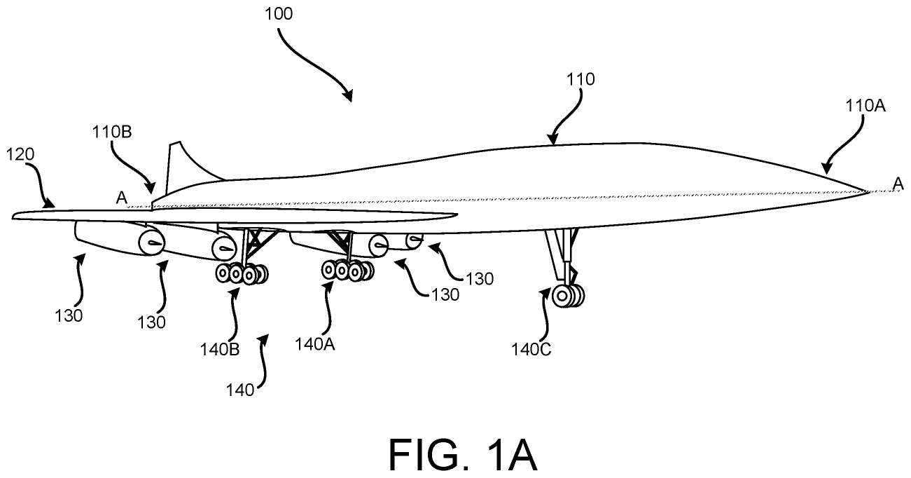

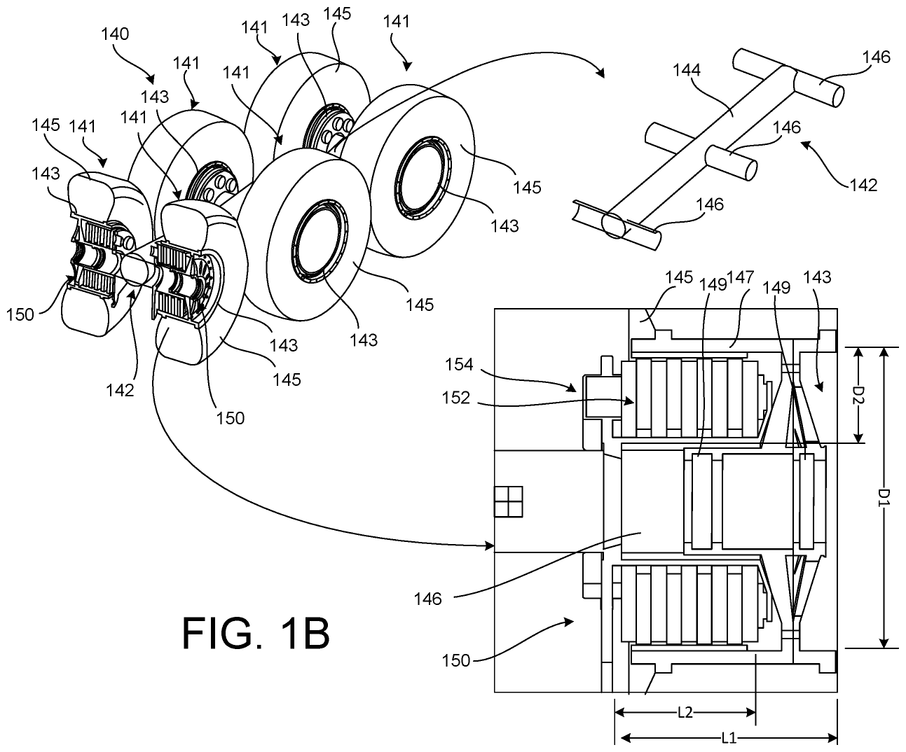

FIG. 1A is a perspective view of an example aircraft 100, provided simply for purposes of discussion and illustration. The principles to be described herein may be applied to other types of aircraft/air vehicles, having other configurations, and/or including other features and/or combinations of features arranged similarly to or differently from what is explicitly shown in FIG. 1A, which may benefit from a wheel and brake assembly providing increased braking energy.

The example aircraft 100 is defined by an aircraft structure, or an aircraft body. The structure, or body, of the example aircraft 100 includes a main body, or a fuselage 110, extending from a front end portion 110A to an aft end portion 110B. The structure, or body, of the example aircraft 100 includes a pair of wings 120 (one of which is shown in FIG. 1A) on first and second side portions of the fuselage 110. A propulsion system of the example aircraft 100 may be mounted in and/or on the structure, or body, of the aircraft 100. In the example shown in FIG. 1A, the propulsion system includes a plurality of engines 130 mounted on the wings 120. The example arrangement shown in FIG. 1A includes four engines 130 symmetrically arranged about a longitudinal centerline A of the example aircraft 100, simply for purposes of discussion and illustration. The principles to be described herein can be applied to aircraft including more, or fewer engines 130, mounted differently, for example, at different portions of the structure defining the aircraft 100.

The example aircraft 100 shown in FIG. 1A includes landing gear 140. In some examples, the landing gear 140 may be selectively retractable into a portion of the aircraft 100. For example, the landing gear 140 may be selectively retractable into a corresponding portion of the fuselage 110, or other portion of the body of the aircraft 100. In this type of configuration, the landing gear 140 may remain in a stowed state within the body of the aircraft 100 during cruise operation of the aircraft 100, and deployed for landing. In some examples, the landing gear 140 may be in a permanently deployed state. In the example shown in FIG. 1A, the example landing gear 140 includes main landing gear 140A, 140B (i.e., arranged port and starboard with respect to the fuselage 110) and nosewheel landing gear 140C, simply for purposes of discussion and illustration. In the example shown in FIG. 1A, the example landing gear 140 (140A, 140B, 140C) each include a plurality of wheels coupled to a respective oleo strut, or shock absorbing strut, simply for purposes of discussion and illustration. The principles to be described herein can be applied to other arrangements of landing gear and/or to landing gear including more, or fewer, wheels arranged similarly to or differently from the example shown in FIG. 1A. In some examples, one or more of the wheels of each of the example landing gear 140 (140A, 140B, 140C) may include a brake assembly, that provides for braking and deceleration of the aircraft during landing and/or taxiing.

FIG. 1B illustrates some example features of a wheel and brake assembly of the example landing gear 140 (140A and/or 140B and/or 140C) shown in FIG. 1A. In the example arrangement shown in FIG. 1B, a plurality of wheel assemblies 141 are mounted on a bogie 142. The bogie 142 includes a plurality of axle portions 146 extending outward from a central support portion 144. Each wheel assembly 141 includes a tire 145 mounted on a rim 147, with a hub portion 143 including structure that provides for coupling of the wheel assembly 141 to a respective axle portion 146 of the bogie 142. A brake assembly 150, including a rotor and stator assembly 152, is received in a space defined within a portion of a volume defined within the rim 147. A remainder of the installation volume defined within the rim 147 is occupied by the axle portion 146 of the bogie 142, and structural components of the hub portion 143 that extend radially inward from the rim 147. In some examples, the installation volume formed within the rim 147 may be defined by a length L1 from between an inboard end and an outboard end of the rim 147, and a diameter D1 of the inner periphery of the rim 147. As shown in FIG. 1B, a length L2 associated with the brake assembly 150 may be less than the overall length L1 of the installation volume due to, for example, volume occupied by structural components of the hub portion 143. Similarly, a dimension D2 associated with the brake assembly 150 may be less than the overall diameter D1 of the installation volume due to, for example, volume occupied by the axle portion 146 of the bogie 142.

One or more bearings 149 may be positioned between the hub portion 143 and the axle portion 146, to facilitate the coupling of the wheel assembly 141 to the axle portion 146. In the example shown in FIG. 1B, the brake assembly 150 includes a rotor and stator assembly 152 positioned between the axle portion 146, the hub portion 143, and the rim 147, with a piston assembly 154 selectively applying a force to the rotor and stator assembly 152 that presses the rotors against the stators of the rotor and stator assembly 152 to generate braking force in the wheel assembly 141.

In general, as aircraft size and/or weight increases, and/or aircraft landing configuration changes, additional braking energy may be needed to safely operate the aircraft during and after landings and rejected takeoffs. In some examples, this additional braking energy may be absorbed by increasing a size and/or a braking capacity of one or more of the brake assemblies. In some examples, increases in size and/or braking capacity of one or more of the brake assemblies may drive a corresponding increase in size and/or weight of the wheel assemblies in which the break assemblies are installed, may drive changes in the configuration of the landing gear and associated structure, and the like. Such changes may drive increases in overall weight and/or overall configuration of the aircraft, which may, in turn, adversely impact aircraft performance.

An aircraft wheel and brake assembly, in accordance with implementations described herein, may provide for increased brake mass, or braking energy, or braking capacity, within a given installation volume. An aircraft wheel and brake assembly, in accordance with implementations described herein, may provide such increased brake mass, or braking energy, or braking capacity, without the need to increase a size and/or a weight of the braking system, thus avoiding associated weight and/or drag penalties.

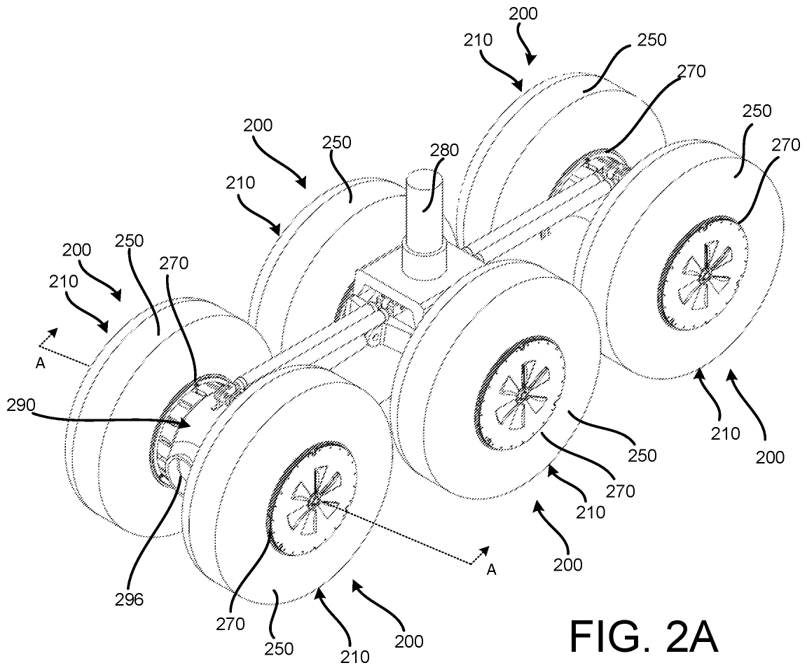

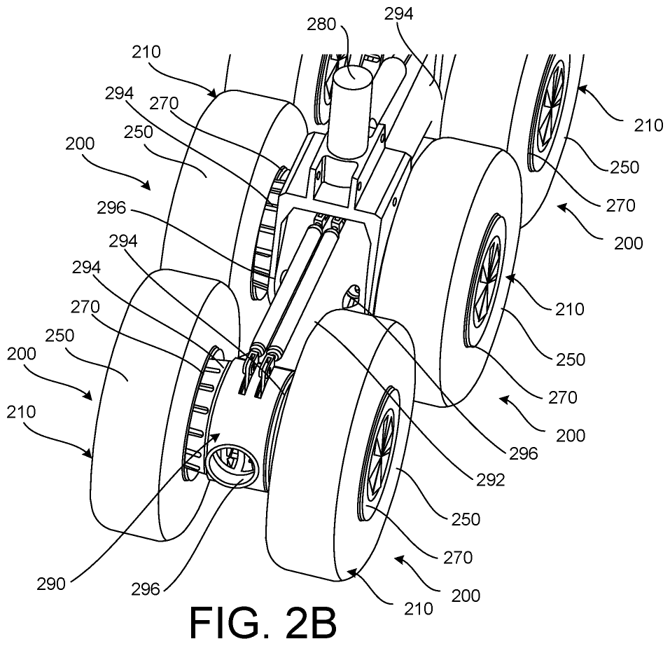

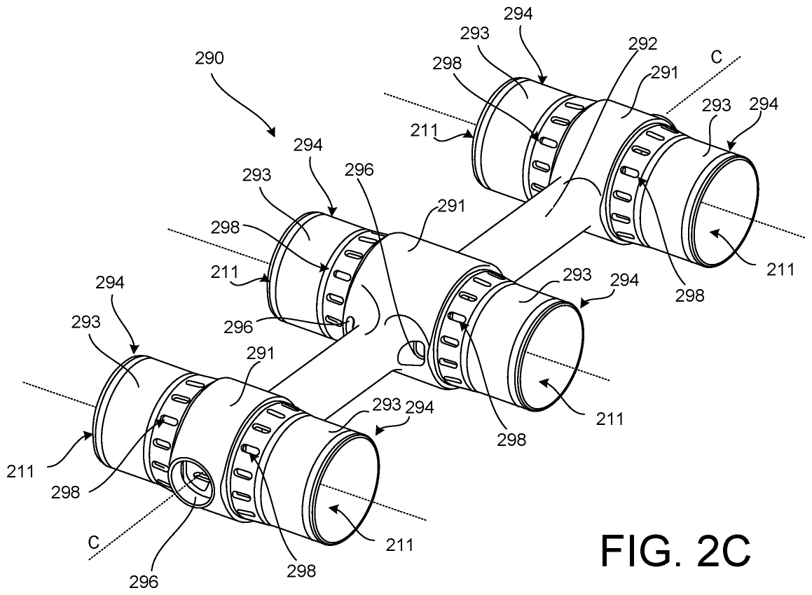

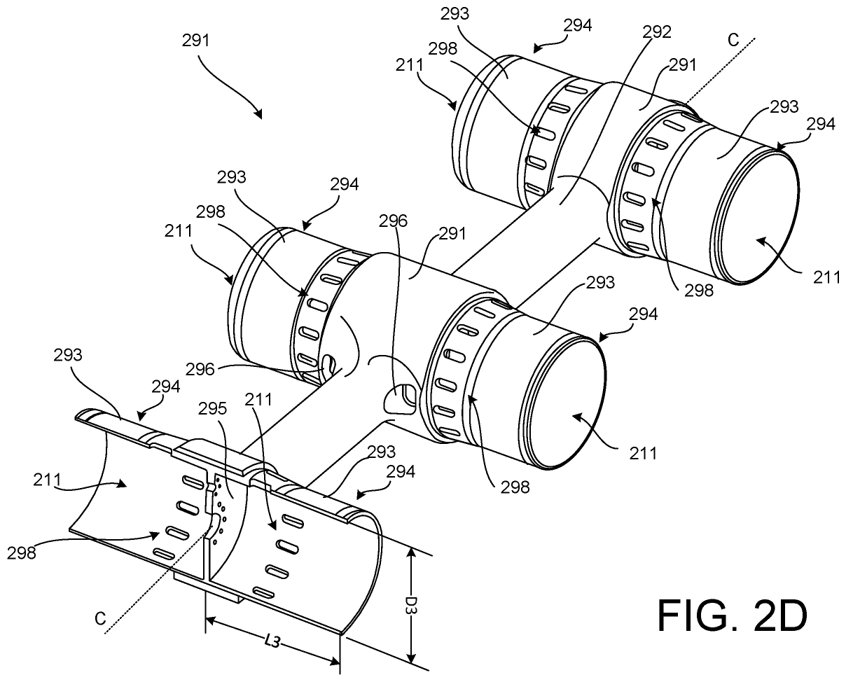

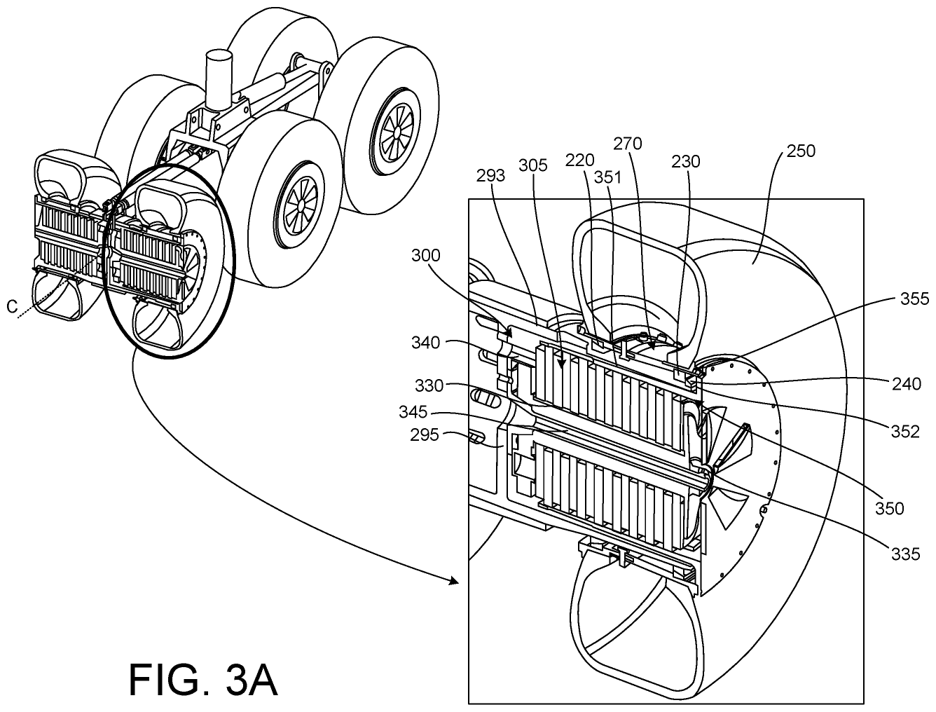

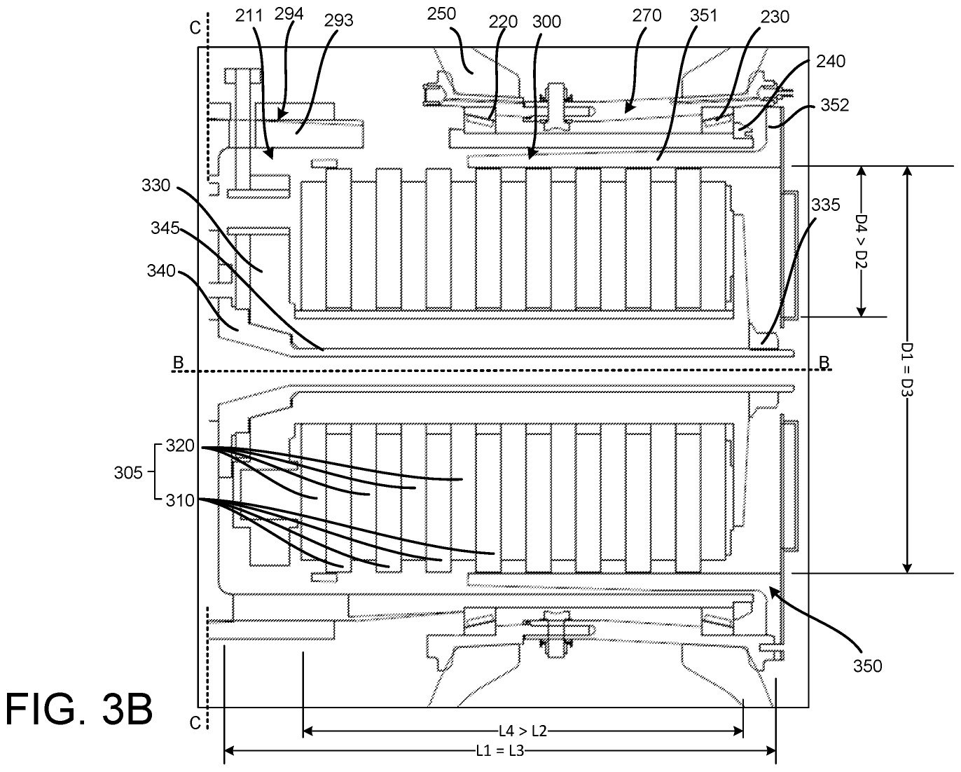

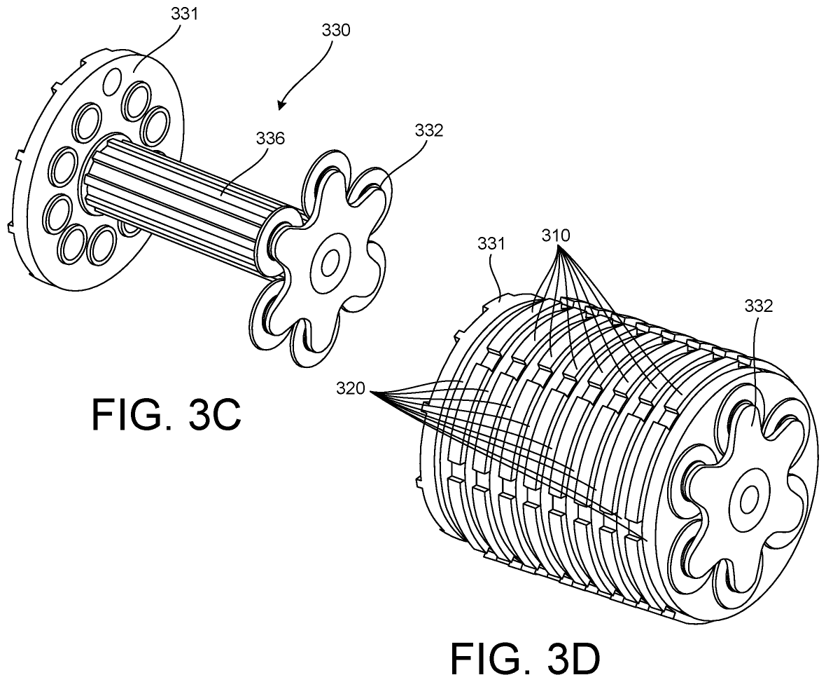

FIGS. 2A-3D illustrate features of an example aircraft wheel and brake assembly 200, in accordance with implementations described herein. The example aircraft wheel and brake assembly 200 may be installed on an aircraft, such as the example aircraft 100 shown in FIG. 1A, or other aircraft not explicitly shown herein, to provide increased brake mass, or braking energy, or braking capacity within a given installation volume allocated for a braking assembly.

FIG. 2A is a side perspective view, and FIG. 2B is a top perspective view, of the example aircraft wheel and brake assembly 200. FIG. 2C is a perspective view of a bogie 290 of the example aircraft wheel and brake assembly 200 shown in FIGS. 2A and 2B. FIG. 2D is a partial cutaway view of the example bogie 290 shown in FIG. 2C. FIGS. 3A and 3B are partial cross-sectional views, taken along line A-A of FIG. 2A, illustrating an example brake assembly 300 installed in an example wheel assembly 210 of the example aircraft wheel and brake assembly 200 shown in FIGS. 2A and 2B. FIG. 3D is a perspective view of an example carrier 330 of the example brake assembly 300 shown in FIGS. 3A and 3B. FIG. 3D is a perspective view of an example rotor and stator assembly 305 mounted on the example carrier 330 shown in FIG. 3C.

As shown in FIGS. 2A-2D, the example wheel and brake assembly 200 includes a plurality of wheel assemblies 210 mounted on a bogie 290. The bogie 290 includes a central support member 292 extending in a direction corresponding to a longitudinal centerline C of the bogie 290. A plurality of axle portions 294 are positioned substantially orthogonally to, or transverse to the central support member 292, and the longitudinal centerline C of the bogie 290. In the example shown in FIGS. 2A-2D, the axle portions 294 are formed separately from the central support member 292 of the bogie 290, and are fit through and secured in respective openings defined by collar portions 291 formed in the central support member 292 of the bogie 290, simply for purposes of discussion and illustration. In some examples, the central support member 292 and the axle portions 294 of the bogie 290 may be formed integrally, as a single unit. In some examples, the bogie 290 includes at least one opening 296. The at least one opening 296 may guide hydraulic lines and/or electrical lines into the wheel and brake assembly 200. In the example shown in FIGS. 2A-2C, the bogie 290 includes a plurality of openings 296 formed in the central support member 292 of the bogie 290. The bogie 290 is couplable to a shock absorbing strut, or oleo strut 280 of the landing gear structure of an aircraft, such as the example aircraft 100 shown in FIG. 1A, or another aircraft not explicitly shown herein.

Each of the wheel assemblies 210 is coupled to a respective axle portion 294 of the bogie 290. Each of the wheel assemblies 210 includes a tire 250 mounted on a rim 270. The rim 270 is, in turn, coupled to the axle portion 294 of the bogie 290. In some examples, at least one bearing (for example, a first bearing 220 and a second bearing 230, as shown in the example arrangement illustrated in FIG. 3B) may be positioned between the rim 270 and the corresponding axle portion 294 of the bogie 290 to facilitate the mounting of the wheel assembly 210 to the bogie 290. In some examples, a retaining ring 240 (see FIG. 3B) may maintain a position of the at least one bearing relative to the rim 270 and the corresponding axle portion 294 of the bogie 290. In the example shown in FIGS. 2A-2D, each of the axle portions 294 includes an outer wall 293 defining a hollow interior space 211. In some examples, an end wall 295 is positioned at an intermediate position between the hollow interior spaces 211 of adjoining axle portions 294. In some examples, the end wall 295 is aligned with the central support member 292 of the bogie 290. The hollow interior space 211 formed within each axle portion 294 may define an installation volume in which a brake assembly 300 may be accommodated. As shown in FIG. 2D, the interior space 211 defining the installation volume in which the brake assembly 300 of the particular wheel assembly 210 may be received may be defined by a length L3 and a diameter D3 of the corresponding axle portion 294 of the bogie 290. In an example in which a tire and rim configuration is substantially the same as the configuration shown in FIG. 1B, the length L3 and diameter D3 of the installation volume shown in FIGS. 2D and 3B may be substantially the same as the length L1 and the diameter D1 of the installation volume shown in FIG. 1B.

As shown in FIGS. 3A-3D, the example brake assembly 300 includes a rotor and stator assembly 305 mounted on a carrier 330. The rotor and stator assembly 305 includes a plurality of rotors 310, alternately arranged with a plurality of stators 320, on a carrier 330. As shown in FIGS. 3A-3D, the plurality of rotors 310 and plurality of stators 320 may be mounted on a central support member 336 of the carrier 330, between a first end plate 331 and a second end plate 332 of the carrier 330. In some examples, a fastener 335, such as, for example, a retaining nut, secures the carrier 330 in place on a mounting rod 345 fixed within the axle portion 294 of the bogie 290. In some examples, an inboard end of the mounting rod 345 may be fixed at the end wall 295, and an outboard end of the mounting rod 345 may be accessible via the open end portion of the axle portion 294. A rotor cage 350 surrounds the rotor and stator assembly 305, and is fixed to the rim 270 by a plurality of fasteners 355.

In some examples, the plurality of rotors 310 may rotate together with the wheel assembly 210, for example, about a central axis B of the wheel assembly 210/brake assembly 300. In some examples, geometry at an outer peripheral portion, or outer diameter, of the plurality of rotors 310 may be keyed to, or fixed to, the rotor cage 350. In particular, geometry at the outer peripheral portion, or outer diameter, of the plurality of rotors 310 may be keyed to, or fixed to, corresponding geometry in a cylindrical wall defining a body portion 351 of the rotor cage 350, with a flange portion 352 of the rotor cage 350 fixed to the rim 270 of the wheel assembly 210. The fixing of the flange portion 352 of the rotor cage 350 to the rim 270 may, in turn, fix the rotors 310 to the rim 270/wheel assembly 210, such that the plurality of rotors 310 rotate together with the rotor cage 350 and the rim 270/the wheel assembly 210. In some examples, geometry at an inner peripheral portion, i.e., an inner diameter, of the plurality of stators 320 may key, or fix, the plurality of stators 320 to the carrier 330, which is in turn fixed in the axle portion 294 of the bogie 290, such that the plurality of stators 320 remain stationary relative to the plurality of rotors 310. In some examples, actuation of at least one cylinder 340 presses the (stationary) stators 320 against the (rotating) rotors 310. Friction between the (stationary) stators 320 pressed against the (rotating) rotors 310 causes a deceleration of the rotational speed of the rotors 310, and a corresponding deceleration of the rotational speed of the wheel assembly 210, and the aircraft.

In the example arrangement shown in FIG. 1B, the brake assembly 150 is positioned surrounding the axle portion 146 of the bogie 142, thus occupying only a portion of the installation volume formed within the rim 147 of the wheel assembly 141 that is not otherwise occupied by the axle portion 146 of the bogie 142. In contrast, in the example arrangement shown in FIGS. 2A-3D, the interior space 211 defining the installation volume formed within the outer wall 293 and the end wall 295 of the axle portion 294 of the bogie 290 corresponds to substantially all of the installation volume defined by the hub portion of the wheel assembly 210. That is, the length L3 and diameter D3 of the installation volume shown in FIGS. 2D and 3B may be substantially the same as the length L1 and diameter D1 of the installation volume shown in FIG. 1B. However, in the example arrangement shown in FIGS. 2A-3D, substantially all of the installation volume is available to accommodate the brake assembly 300. This results in the brake assembly 300 having an overall length L4 (that is greater than the length L2 of the brake assembly 150 shown in FIG. 1B), and having a dimension D4 (that is greater than the dimension D2 of the brake assembly 150 shown in FIG. 1B). This greater installation volume, for a given tire size and a corresponding given hub size, may allow for installation of a larger brake assembly 300, having a greater brake mass/generating greater braking energy absorption. This greater brake mass/greater braking energy may be provided without increasing tire size and/or rim size/structure, and/or a corresponding increase in size of the landing gear structure to accommodate the larger tire and/or rim size and/or structure. This greater brake mass/greater braking energy may thus be provided without appreciable increases in weight and/or other aerodynamic parameters which could result in increases in drag, and adversely impact overall aircraft efficiency and/or performance.

In the example arrangement shown in FIGS. 2A-3D, the brake assembly 300 is accessible from an outboard side of the wheel assembly 210. This arrangement may facilitate the removal of the brake assembly 300 from the wheel assembly 210. For example, this arrangement may provide for removal and replacement of the brake assembly 300 from the wheel assembly 210 without relying on removal of the wheel assembly 210 from the landing gear and/or without relying on jacking of the aircraft to facilitate removal of the wheel assembly 210. Simplification of the removal and/or installation of the brake assembly 300 from the wheel assembly 210 may reduce maintenance time and/or cost, and may improve aircraft availability.

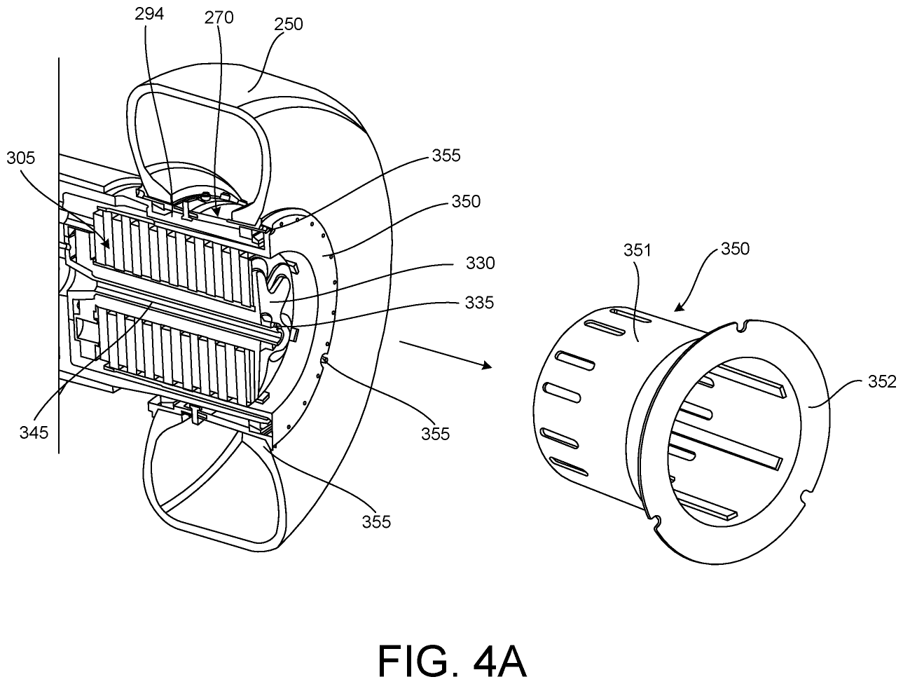

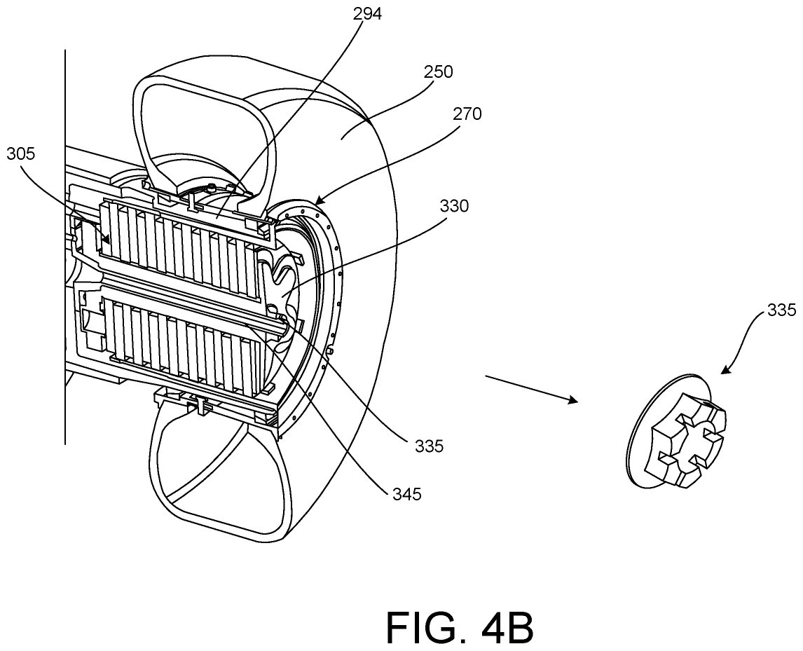

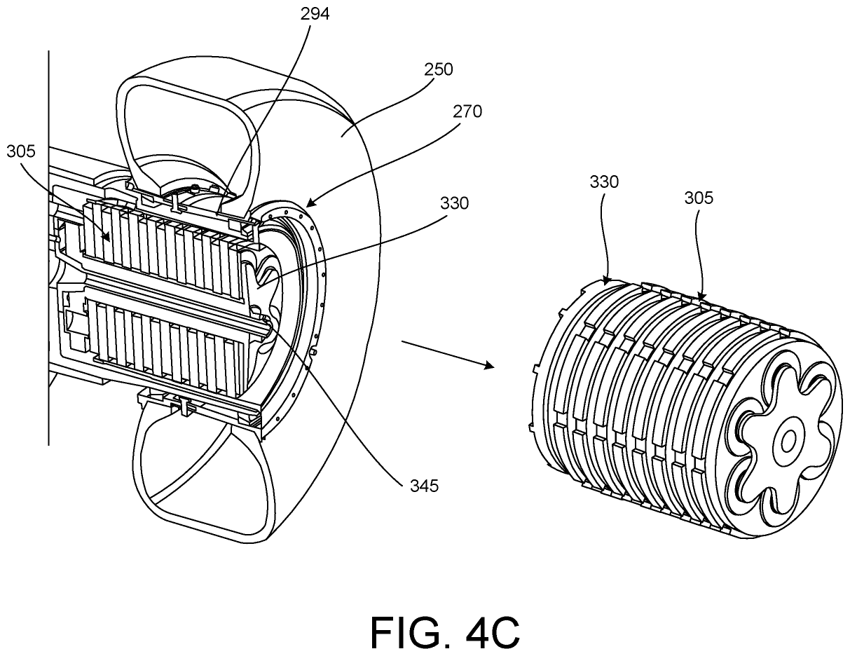

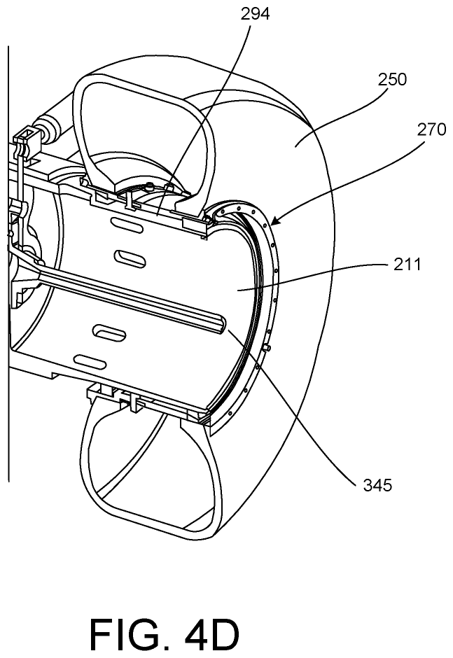

An example process of accessing and removing the brake assembly 300 from the wheel assembly 210 is shown in FIGS. 4A-4D. The example process of removing the brake assembly 300 from the wheel assembly 210 is carried out while the tire 250 and rim 270 of the wheel assembly 210 remain installed on the axle portion 294 of the bogie 290. Thus, in the example process shown in FIGS. 4A-4D, removal of the brake assembly 300 does not rely on removal of the rim 270/tire 250 from the bogie 290 and/or jacking of the aircraft to elevate the landing gear to facilitate removal of the rim 270/tire 250 from the bogie 290.

FIG. 4A provides a cross-sectional view of the wheel and brake assembly 200, in which the wheel and brake assembly 200 is installed on the bogie 290, and the brake assembly 300 is exposed at the outboard side thereof. To initiate removal of the brake assembly 300 from the wheel and brake assembly 200, the plurality of fasteners 355 are removed, to decouple the rotor cage 350 from the rim 270. The removal of the plurality of fasteners 355 allows for movement of the rotor cage 350, disengagement of the outer peripheral portions of the rotors 310 and the rotor cage 350, and removal of the rotor cage 350 from the portion of interior space 211 within the axle portion 294 surrounding the rotor and stator assembly 305. After removal of the rotor cage 350, the fastener 335 may be removed from the distal end portion of the mounting rod 345, as shown in FIG. 4B. Removal of the fastener 335 may allow for axial movement of the rotor and stator assembly 305 mounted on the carrier 330. This may, in turn, allow for removal of the carrier 330 from the interior space 211 in the axle portion 294 in which the brake assembly 300 is received, as shown in FIGS. 4C and 4D. Once the brake assembly 300 has been removed from the axle portion 294 as described above, a new/repaired brake assembly 300 may be installed in the interior space 211 within the axle portion 294 of the bogie 290. Removal of the brake assembly 300 as described above may be accomplished without relying on removal of the entire wheel and brake assembly 200 from the bogie 290/landing gear and/or jacking or other lifting of the aircraft to facilitate the removal of the wheel and brake assembly 200 for removal of the brake assembly 300.

Installation of a new/repaired brake assembly 300 into the axle portion 294 of the bogie 290 may be accomplished in a similar manner. That is, installation of a new/repaired brake assembly 300 may be accomplished in essentially the reverse process of removal of the brake assembly 300 from the wheel and brake assembly 200 described above. For example, with the interior space 211 formed in the axle portion 294 open and accessible at the outboard side as shown in FIG. 4D, the rotor and stator assembly 305 mounted on the carrier 330 may be slidably coupled onto the mounting rod 345 and inserted into the interior space 211 formed in the axle portion 294, as shown in FIG. 4C. As described above, inner peripheral portions of the plurality of stators 320 may be engaged with, or fixed to, corresponding portions of the carrier 330, such that the plurality of stators 320 remain fixed and stationary together with the carrier 330.

With the rotor and stator assembly 305 mounted on the carrier 330 installed on the mounting rod 345 in the interior space 211 of the axle portion 294, the fastener 335 may be fastened to the distal end portion of the mounting rod 345 to fix the rotor and stator assembly 305 within the axle portion 294 of the bogie 290, as shown in FIG. 4B. With the rotor and stator assembly 305 within the axle portion 294 of the bogie 290, the rotor cage 350 may be slidably inserted into the axle portion 294, between the outer peripheral portion of the rotor and stator assembly 305 and the inner peripheral portion of the outer wall 293 of the axle portion 294, and the plurality of fasteners 355 may fix the rotor cage 350 to the rim 270, such that the rotor cage 350 is fixed to and rotates together with the wheel assembly 210. Insertion of the rotor cage 350 into the space between the rotor and stator assembly 305 and the outer wall 293 of the bogie 290 may engage the outer peripheral portions of the plurality of rotors 310 with corresponding portions of the rotor cage 350, such that the plurality of rotors 310 rotate together with the wheel assembly 210. Installation of the brake assembly 300 as described above may be accomplished without relying on removal of the entire wheel and brake assembly 200 from the bogie 290/landing gear and/or jacking or other lifting of the aircraft to facilitate the removal of the wheel and brake assembly 200 for removal/replacement of the brake assembly 300.

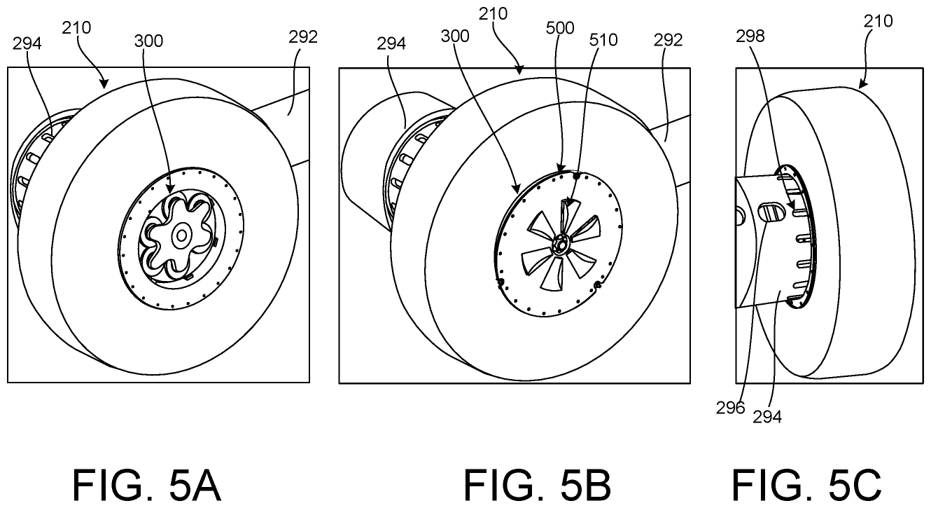

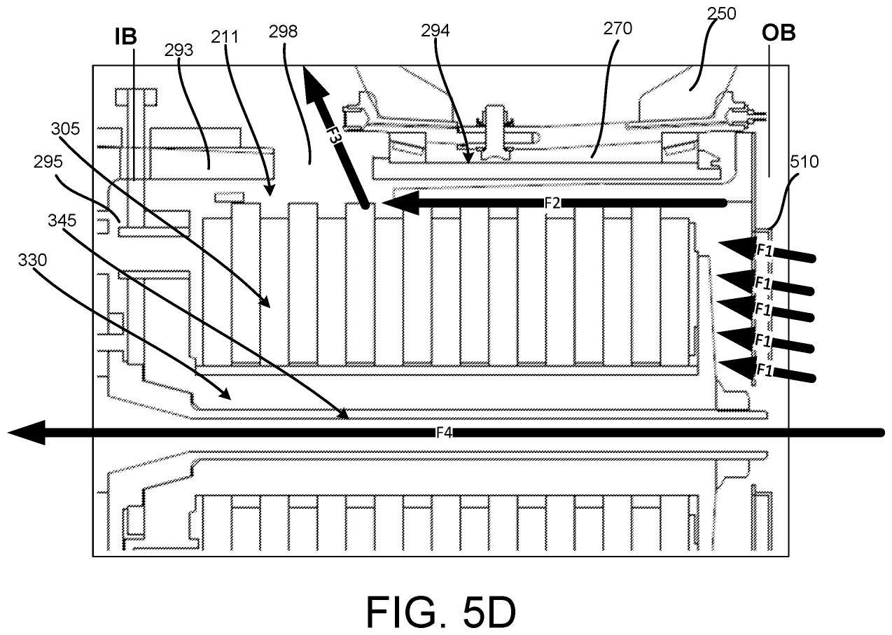

In some examples, the features of the wheel and brake assembly 200 as described above may help to guide cooling through the wheel and brake assembly 200. Improved cooling, and/or a directed flow of cooling air, through the wheel and brake assembly 200 may improve performance and/or reliability of the wheel and brake assembly 200, and/or may extend the usable life of the wheel and brake assembly 200. Improved cooling, and/or a directed flow of cooling air, through the wheel and brake assembly 200 thus enhance the corresponding braking provided to the aircraft by the wheel and brake assembly 200. Cooling through the wheel and brake assembly 200 will be described with respect to FIGS. 5A-5D.

As shown in FIG. 5A, the brake assembly 300 may be accessible, or exposed, at an outboard side of the wheel assembly 210. In some examples, the brake assembly 300 may remain exposed as shown in FIG. 4A during operation of the aircraft. As shown in FIG. 5B, in some examples, a hub cover 500 may be installed at the hub portion of the wheel assembly 210, covering the exposed/accessible portion of the brake assembly 300 installed in the wheel assembly 210. In some examples, the hub cover 500 may define a hub fan 510 that draws external air into the brake assembly 300. In some examples, cooling air may flow from an outboard side OB towards an inboard side IB of the wheel and brake assembly 200 to provide for cooling of the brake assembly 300. That is, in some examples, a configuration of openings 298 in the axle portion 294 of the bogie 290, together with the positioning of the wheel assembly 210 on the axle portion 294 relative to the openings 298, may cause air, drawn in through the hub fan 510 and/or the exposed portion of the brake assembly 300, through the interior space 211 in which the brake assembly 300 is installed, and discharged through the openings 298. In particular, as shown in the partial cross-sectional view of the brake assembly 300 illustrated in FIG. 5D, air may be drawn into the brake assembly 300 through the hub fan 510 at the outboard side OB of the wheel assembly 210. For example, air may flow into the brake assembly 300 through the hub fan 510 in the direction of the arrows F1. The position and/or the configuration of the openings 298 in the axle portion 294 of the bogie 290 may cause that air to flow through the interior space 211, along the rotor and stator assembly 305, in the direction of the arrow F2, for cooling of the rotor and stator assembly 305. The air may be discharged at the inboard side IB of the wheel and brake assembly 200 through the openings 298, in the direction of the arrow F3 shown in FIG. 5D. In some examples, cooling air flowing in through the hub fan 510 may also flow through a central portion of the brake assembly 300, for example, through the mounting rod 345, in the direction of the arrow F4, for discharge at the inboard side IB of the wheel and brake assembly 200.

FIG. 5D illustrates one example of how cooling air flow may flow through the wheel and brake assembly 200. In some examples, cooling air may follow a different flow path through the wheel and brake assembly 200. For example, in some situations, cooling air may enter the wheel and brake assembly 200 at the inboard side IB of the wheel and brake assembly 200, and be discharged at the outboard side OB of the wheel and brake assembly 200. Improved cooling, and/or a directed flow of cooling air, through the wheel and brake assembly 200 may improve performance and/or reliability and/or durability of the wheel and brake assembly 200, thus enhancing the corresponding braking provided to the aircraft.

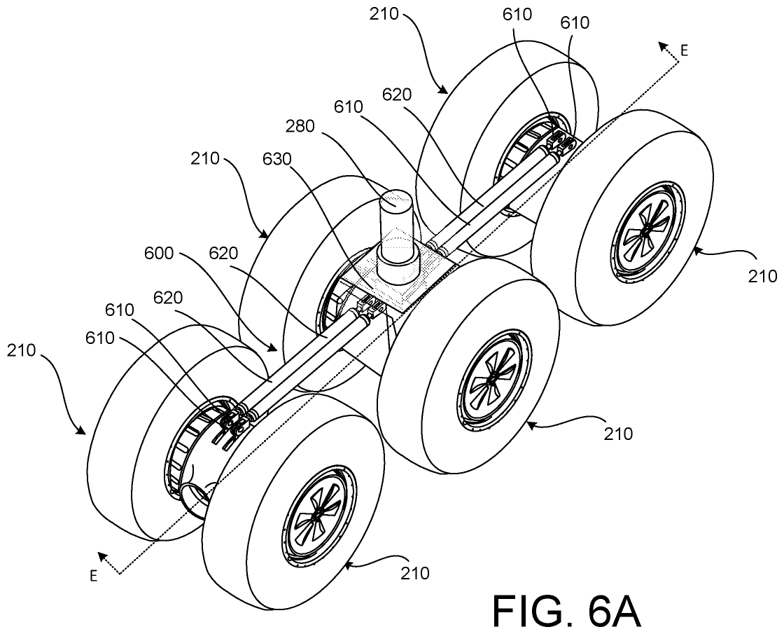

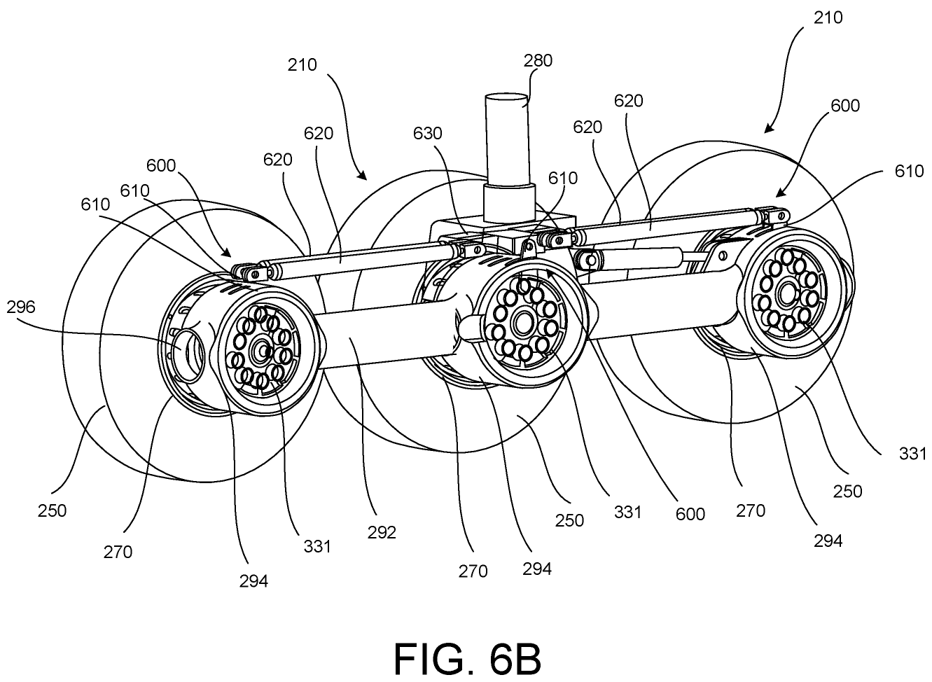

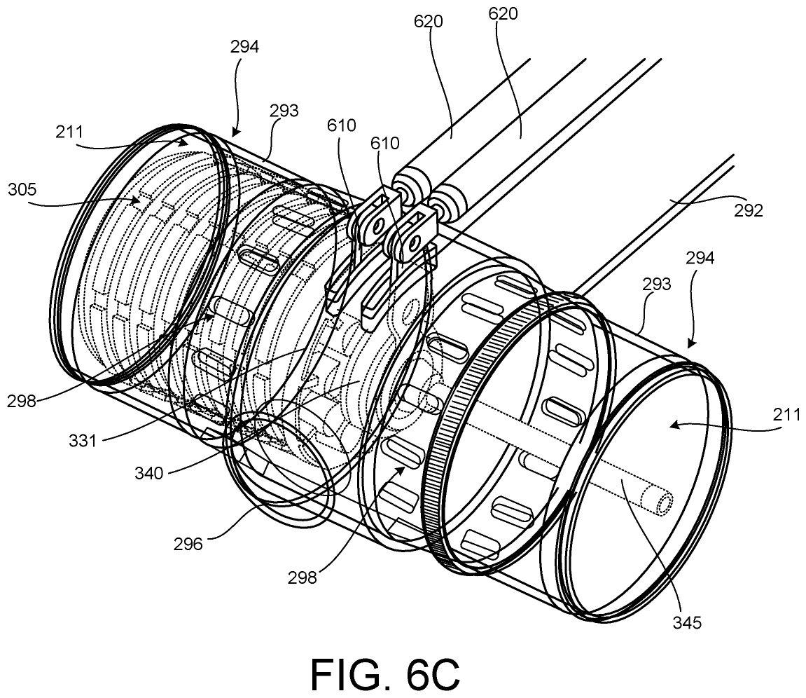

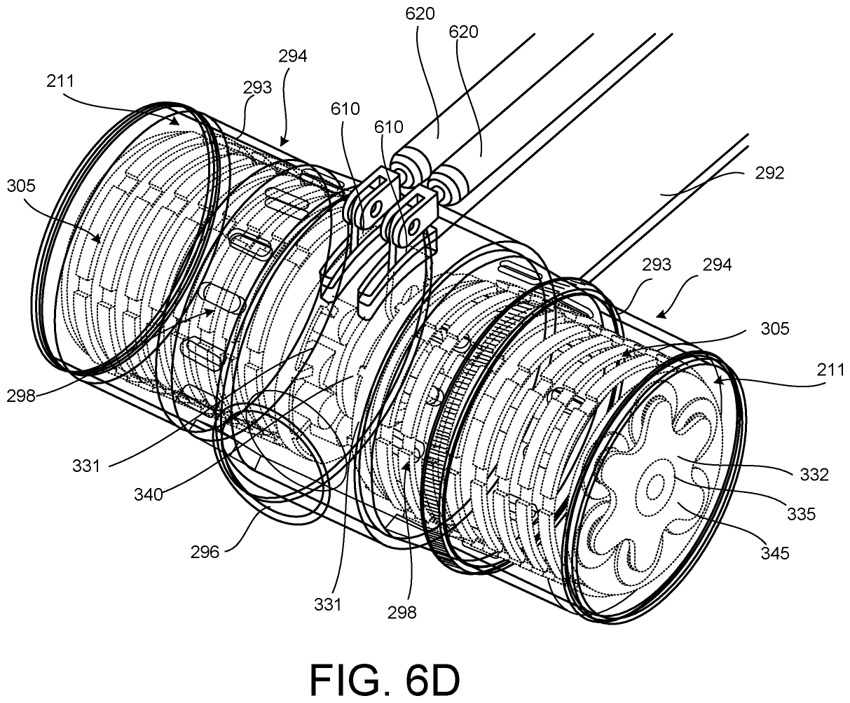

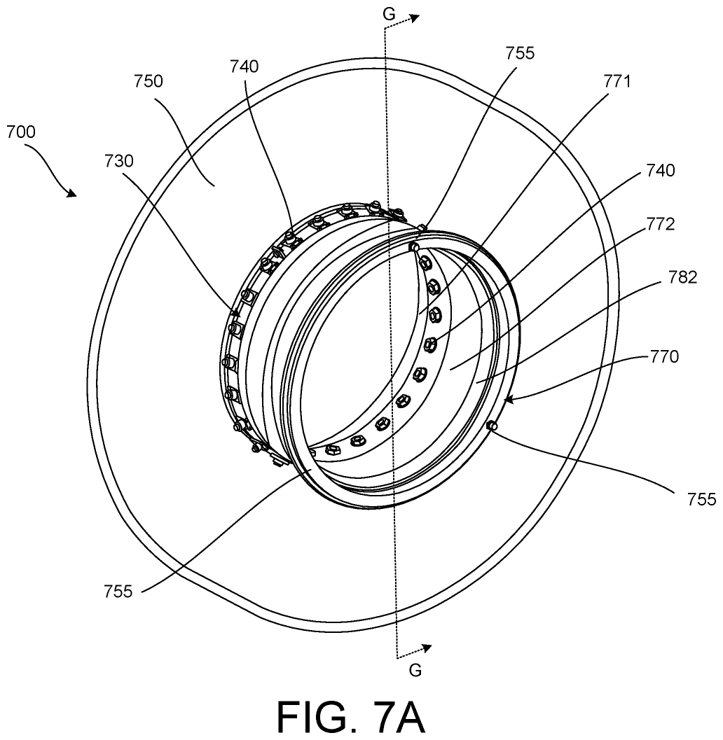

Landing, and application of braking forces by the brake assemblies 300, generates a torque load at each of the wheel and brake assemblies 200 coupled to the landing gear by the bogie 290. In some examples, a torque attenuation system may be coupled to one or more of the wheel and brake assemblies 200 coupled to the bogie 290. The torque attenuation system may distribute torque, generated during landing and/or operation of the brake assemblies 300 for deceleration, amongst the wheel and brake assemblies 200, and/or transfer at least a portion of these forces from the wheel and brake assemblies 200 and/or bogie 290 to be absorbed by the oleo strut 280. An example torque attenuation device 600 will be described with respect to FIGS. 6A-6D. FIG. 6A is a perspective view, and FIG. 6B is a partial cross-sectional view, taken along line E-E of FIG. 6A. FIGS. 6C and 6D are partially transparent views of a connection of the torque attenuation device 600 with the wheel and brake assemblies 200.

The example torque attenuation device 600 may include one or more torque brackets 610 coupled to one or more corresponding torque rods 620. In the example arrangement shown in FIGS. 6A-6D, a torque bracket 610 is provided for each brake assembly 300 of each wheel and brake assembly 200 coupled to the bogie 290. In the example arrangement shown in FIGS. 6A-6D, each torque bracket 610 is coupled the oleo strut 280 via a central bracket 630. In the example arrangement shown in FIGS. 6A-6D, in which six wheel and brake assemblies 200 (i.e., three pairs of two wheel and brake assemblies 200) are provided, the torque brackets 610 of the four outermost wheel and brake assemblies 200 are coupled to the oleo strut 280 via respective torque rods 620 and the central bracket 630, with the torque brackets 610 of the two central wheel and brake assemblies 200 coupled to the oleo strut 280 via the central bracket 630, simply for purposes of discussion and illustration. The principles to be described herein may be applied to other arrangements and/or combinations of torque brackets 610 and/or torque rods 620.

As shown in detail in FIG. 6C, each torque bracket 610 may have a first end coupled to an inboard end portion of a respective mounting rod 345. A second end portion of the torque bracket 610 may extend out, through the outer wall 293 and through the collar portion 291 of the bogie 290, for connection to a first end portion of a corresponding torque rod 620. The second end portion of each torque rod 620 may be coupled to the central bracket 630 provided on the oleo strut 280. In absence of a means by which torque generated during landing and application of braking forces can be transferred to be absorbed by the oleo strut, these forces would be forced into the central support member 292 of the bogie 290. The transfer of these forces into the central support member 292 of the bogie 290 generate moment forces in the central support member 292 that overload the forward wheel and brake assemblies 200, causing non-uniform loading of the wheel and brake assemblies 200 and a nose-down pitching at the forward end portion of the aircraft. In contrast, by directing at least a portion of these forces, through the torque brackets 610 and torque rods 620, into the oleo strut 280, weight, landing forces, and braking forces may be more uniformly distributed amongst the multiple wheel and brake assemblies 200.

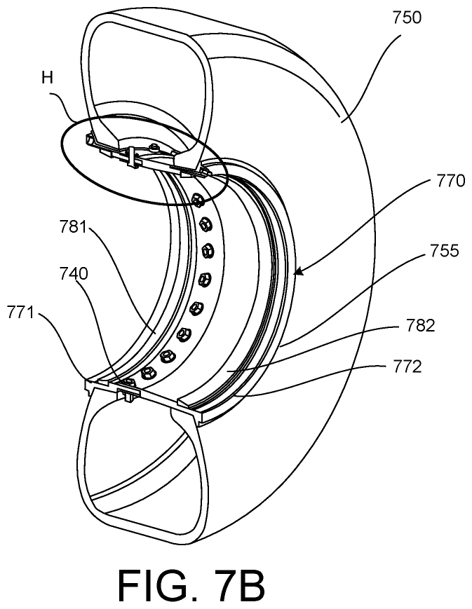

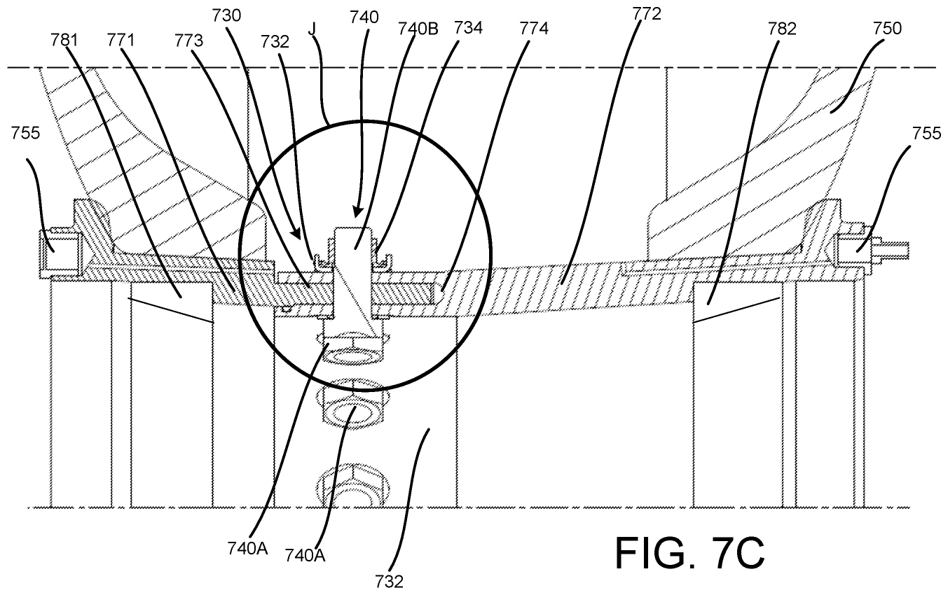

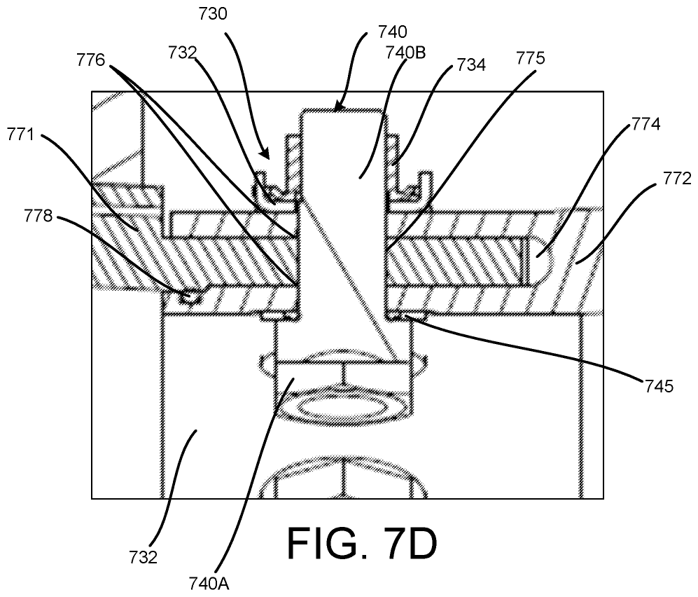

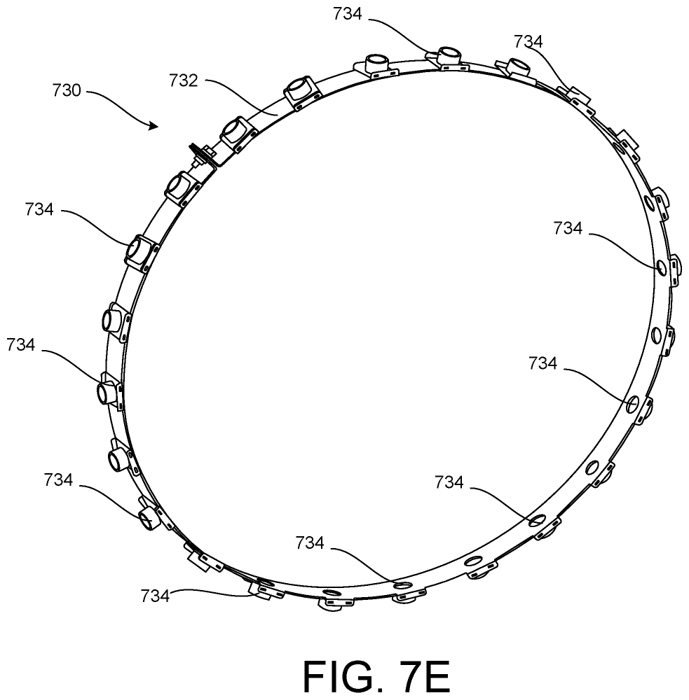

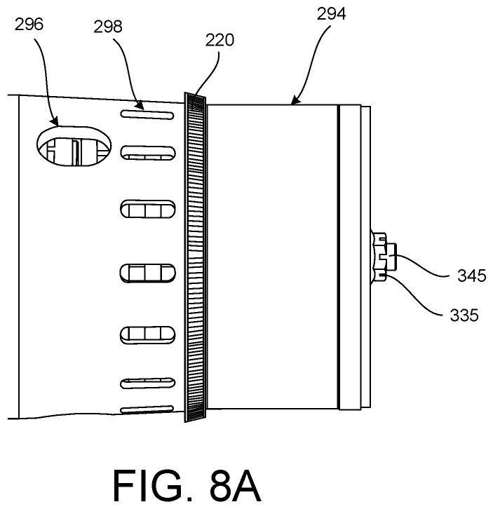

FIGS. 7A-7E illustrate an example wheel assembly 700, in accordance with implementations described herein. In some examples, the example wheel assembly 210 described above can include some, or all, of the features of the example wheel assembly 700 to be described with respect to FIGS. 7A-7E. FIG. 7A is a perspective view of the example wheel assembly 700. In FIG. 7A, a tire 750 of the example wheel assembly 700 is shown in a transparent manner, so that components of a rim assembly 770 on which the tire 750 is mounted are more easily visible. FIG. 7B is a cross-sectional view taken along line G-G of FIG. 7A. FIG. 7C is a close-in view of an area H identified in FIG. 7B. FIG. 7D is a close-in view of an area J identified in FIG. 7C. FIG. 7E is a perspective view of an example fastening ring 730 of the example rim assembly 770.

As shown in FIGS. 7A-7E, the example wheel assembly 700 includes a tire 750 mounted on a rim assembly 770. In some examples, the rim assembly 770 includes multiple rim portions. In some examples, the multiple rim portions include multiple ring-shaped portions that are attached at one or more intermediate portions of the rim assembly. In some examples, the example rim assembly 770 including multiple rim sections may accommodate the mounting of a relatively rigid, reinforced tire on the rim assembly 770. In some examples, the example rim assembly 770 may direct load from the tire 750 into one or more bearings positioned between the example rim assembly 770 and an axle (such as, for example, the axle portion 294 of the bogie 290 described above) on which the rim assembly 770 and tire 750 are mounted. In some examples, the directing of the load from the tire 750 substantially directly into the one or more bearings may represent a reduction in mass moment of inertia when compared to, for example, the example tire 145 and hub portion 143 described above with respect to FIG. 1B.

As shown in FIGS. 7A-7E, the example rim assembly 770 includes a first rim portion 771 coupled to a second rim portion 772. In some examples, the first rim portion 771 and the second rim portion 772 may be coupled by a plurality of fasteners 740. In some examples, the plurality of fasteners 740 may extend through the first rim portion 771, the second rim portion 772, and into a fastening ring 730 to couple the first rim portion 771 and the second rim portion 772. In some examples, the fastening ring 730 may provide for retention of the plurality of fasteners 740 relative to the first rim portion 771 and the second rim portion 772. In some examples, a first bearing surface 781 may be defined on the first rim portion 771. In some examples, a second bearing surface 782 may be defined on the second rim portion 772. In some examples, at least one valve 755 may be provided on the rim assembly 770. The at least one valve 755 may provide for the pressurization/depressurization of the tire 750, monitoring of the pressure held by the tire 750 and the like.

In some examples, a slot 774 may be formed in the second rim portion 772. An arm portion 773 of the first rim portion 771 may be received in the slot 774. Insertion of the arm portion 773 of the first rim portion 771 into the slot 774 of the second rim portion 772 may circumferentially align the first rim portion 771 and the second rim portion 772. Insertion of the arm portion 773 of the first rim portion 771 into the slot 774 formed in the second rim portion 772 may form an overlap region, or a coupling region, between the first rim portion 771 and the second rim portion 772, identified by the area J shown in FIG. 7C, and shown in more detail in FIG. 7D. In some examples, each of the plurality of fasteners 740 may extend through openings 775, for example, radially extending openings, formed through the first rim portion 771, and openings 776 in the second rim portion 772), and into the fastening ring 730. The openings 775 in the first rim portion 771 may be circumferentially arranged along a portion of the first rim portion 771 corresponding to the arm portion 773. The openings 776 in the second rim portion 772 may be circumferentially arranged along a portion of the second rim portion 772 corresponding to the slot 774. The openings 775 in the first rim portion 771 and the openings 776 in the second rim portion 772 may be formed in the coupling region (i.e., where the arm portion 773 is inserted into the slot 774), corresponding to a position of the fastening ring 730. In some examples, distal end portions of the plurality of fasteners 740 may be retained by the fastening ring 730, so as to secure a relative position of the first rim portion 771 and the second rim portion 772.

As shown in FIG. 7E, in some examples, the fastening ring 730 may include a ring-shaped band portion 732. In this example arrangement, the band portion 732 may have a size and/or a shape and/or a contour corresponding to an outer peripheral contour, or an outer diameter, or an outer circumferential surface, of the second rim portion 772, so that the fastening ring 730 is fitted against the outer peripheral surface of the second rim portion 772. The fastening ring 730 may include a plurality of openings (some of which are labeled with the reference numeral 734) formed in the band portion 732. The plurality of openings 734 may be circumferentially arranged along the band portion 732. In some examples, a number and an arrangement of the plurality of openings 734 correspond to the plurality of openings 775 formed in the first rim portion 771 and the plurality of openings 776 formed in the second rim portion 772, at the coupling region, where the first rim portion 771 and the second rim portion 772 overlap (for example, at a position where the arm portion 773 is received in the slot 774 in this example arrangement). Alignment of the plurality of openings 734 formed in the fastening ring 730 with the corresponding openings 775, 776 formed in the coupling region between the first rim portion 771 and the second rim portion 772, may allow for insertion of the plurality of fasteners 740 through the aligned openings.

In some examples, the plurality of fasteners 740 may be threaded fasteners, and the plurality of openings 734 in the fastening ring 730 may be threaded openings, so that end portions of the plurality of fasteners 740 may be threadably engaged in and positively retained by the plurality of threaded openings 734. In some examples, the plurality of openings 734 may be in the form of threaded nuts that are fixed to the band portion 732 of the fastening ring 730. In an example in which the plurality of openings 734 are in the formed of threaded nuts configured to threadably engage the plurality of fasteners 740, the plurality of openings 734 may include wall portions having threaded interior surfaces configured to threadably engage the plurality of fasteners 740.

In some examples, a sealing washer 745 may be positioned between a head portion 740A of each fastener 740 and an inner peripheral surface of the second rim portion 772, as shown in FIG. 7D. In some examples, a threaded shaft portion 740B of each fastener may be engaged, for example, threadably engaged, in a corresponding threaded nut formed at a corresponding threaded opening 734 of the fastening ring 730. In some examples, a sealing ring 778, or O-ring, may be positioned between an inner surface of the slot 774 and an outer surface of the arm portion 773, as shown in FIG. 7D.

To mount the tire 750 onto the rim assembly 770, the second rim portion 772 may be mounted on the corresponding inner peripheral portion of the tire 750 (for example, an outboard side of the inner peripheral portion of the tire 750). The fastening ring 730 may be fitted on an outer peripheral portion of the second rim portion 772. The fastening ring 730 may be positioned on the outer peripheral portion of the second rim portion 772 at a position corresponding to the coupling region, i.e., where the slot 774 is formed, and the first and second rim portions 771, 772 overlap in the assembled configuration of the rim assembly 770. A position of the fastening ring 730 on the outer peripheral portion of the second rim portion 772 may be adjusted so that the plurality of openings 734 formed in the fastening ring 730 are aligned with the corresponding plurality of openings 776 extending radially through the slot 774 formed in the second rim portion 772.

With the fastening ring 730 positioned on the outer peripheral portion of the second rim portion 772, and the plurality of openings 734 of the fastening ring 730 aligned with corresponding plurality of openings 776 in the second rim portion 772, the arm portion 773 of the first rim portion 771 may be inserted into the slot 774, and the second rim portion 772 may be mounted on the corresponding inner peripheral portion of the tire 750 (for example, an inboard side of the inner peripheral portion of the tire 750). The plurality of openings 775 formed in the arm portion 773 of the first rim portion 771 may be aligned with the plurality of openings 776 formed in the slot 774 and the plurality of openings 734 formed in the fastening ring 730. With the first rim portion 771, the second rim portion 772 and the 730 positioned, and the openings 775, 776, 734 aligned in this manner, the plurality of fasteners 740 may be inserted through the aligned openings 775, 776, 734 to secure a relative position of the first rim portion 771 and the second rim portion 772, and complete the mounting of the tire 750 on the rim assembly 770. As noted above, in some examples, the plurality of fasteners 740 may be threaded fasteners, and the plurality of openings 734 formed in the fastening ring 730 may be threaded openings, such that the plurality of fasteners 740 are threadably engaged by, and positively retained by, the fastening ring 730. In this example arrangement, the plurality of fasteners 740 coupling the first rim portion 771 and the second rim portion 772 may be in a shear state, thus providing for a more efficient coupling of the first and second rim portions 771, 772 of the rim assembly 770.

The example rim assembly 770 including the first and second rim portions 771, 772 coupled as described above, and the tire 750 mounted to the example rim assembly 770, may direct load from the tire 750 into more directly into the bearing surfaces 781, 782 positioned between the example rim assembly 770 and an axle (such as, for example, the axle portion 294 of the bogie 290 described above) on which the rim assembly 770 and tire 750 are mounted. As noted above, this may represent a reduction in mass moment of inertia when compared to, for example, the tire 145 and hub portion 143 described above with respect to FIG. 1B. That is, in the tire 145 and hub portion 143 described above with respect to FIG. 1B, load is directed from the tire 145 (for example, the sidewalls of the tire 145), onto peripheral portions of the rim 147 that mate with the tire 145, through the structure associated with the hub portion 143, and down to the bearings 149 positioned at the axle portion 146, within an inner diameter of the rotor and stator assembly 152. In contrast, in the example wheel assembly 700 described above, the load path is considerably reduced, as load from the tire 750 can be directed substantially straight to the first and second bearing surfaces 781, 782, without traversing additional structural components to traverse in reaching bearings that are further embedded in the axle portion.

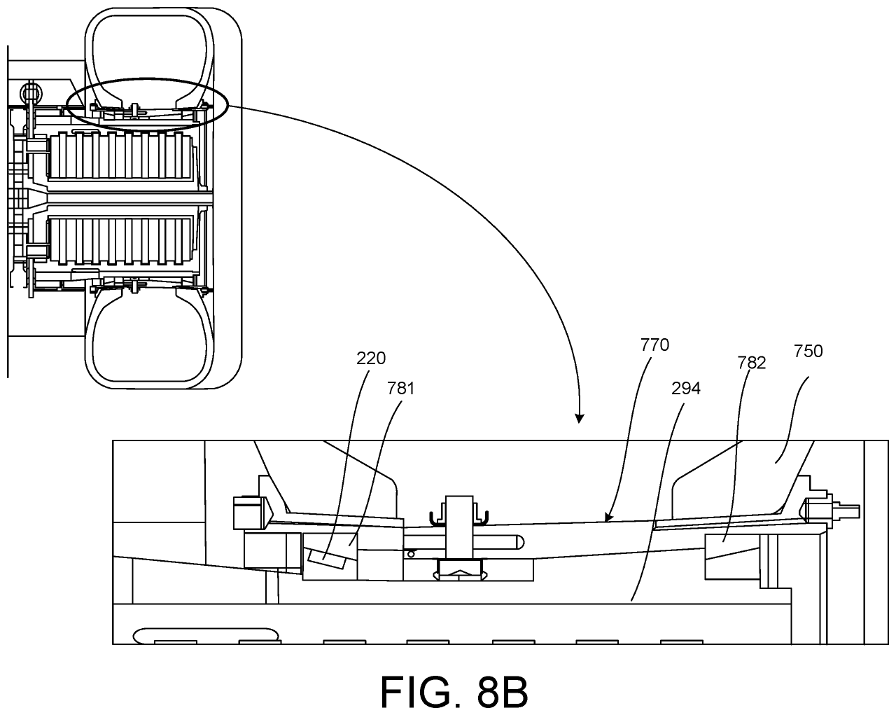

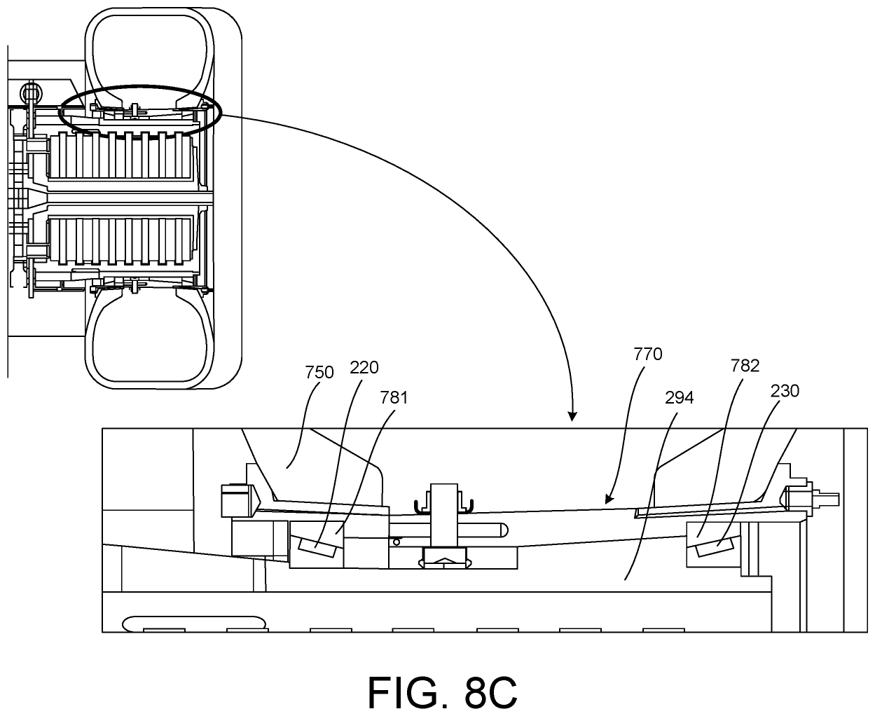

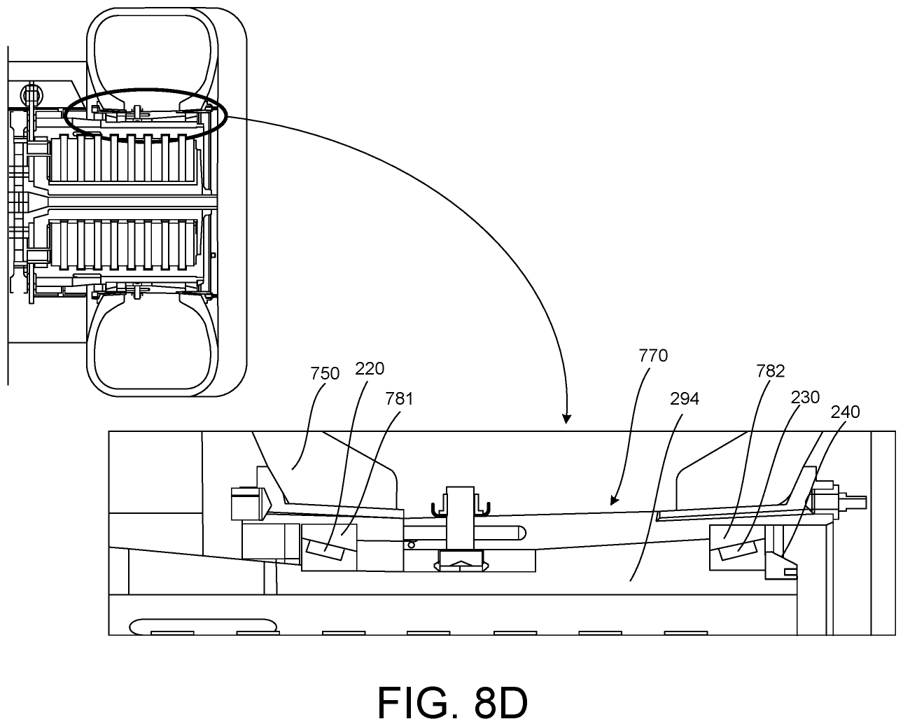

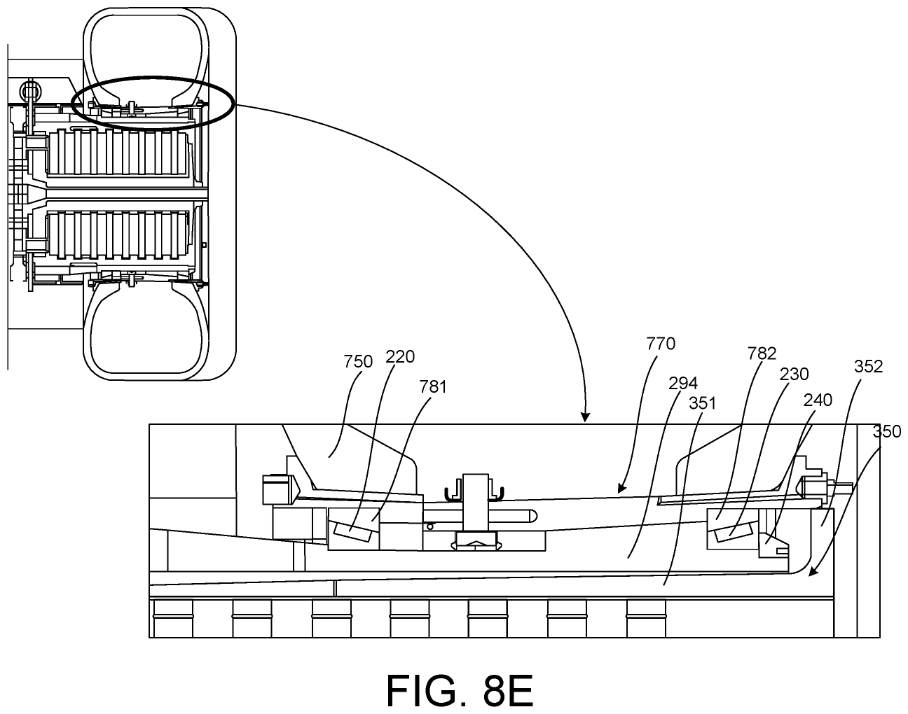

FIGS. 8A-8E illustrate an example process of mounting an example wheel assembly, such as the example wheel assembly 700 described above with respect to FIGS. 7A-7E (or other aircraft wheel assembly), on an axle portion of an aircraft landing gear assembly, such as, for example, the axle portion 294 of the bogie 290 coupled to the landing gear described above.

As shown in FIG. 8A, with the first bearing 220 (for example, the inboard bearing) mounted on the axle portion 294, the wheel assembly 700 may be mounted on the axle portion 294, with the first bearing surface 781 of the rim assembly 770 aligned with the first bearing 220, as shown in FIG. 8B. As shown in FIG. 8C, the second bearing 230 (for example, the outboard bearing) may then be installed between the axle portion 294 and the rim assembly 770, with the second bearing surface 782 of the rim assembly 770 aligned with the second bearing 230. As shown in FIG. 8D, the retaining ring 240 may then be installed on the axle portion 294, against the second bearing 230, and torqued to seat the first bearing 220 and the second bearing 230. The rotor cage 350 may then be positioned with the body portion 351 surrounding the rotor and stator assembly 305, and the flange portion 352 of the rotor cage 350 fastened to the front flange portion of the rim assembly 770 to couple the rotor cage 350 (and the rotors 310 engaged with the rotor cage 350 as described above) to the wheel assembly 700.

Removal of the example wheel assembly 700 from the example axle portion 294 may be carried out substantially in reverse of the process described above with respect to FIGS. 8A-8E. That is, the rotor cage 350 may be de-coupled from the front flange portion of the rim assembly 770 of the wheel assembly 700, so that the rotor cage 350 can be disengaged from the rotors 310 and slidably removed from the interior of the axle portion 294. The retaining ring 240 may then be removed, and the second bearing 230 (i.e., the outboard bearing) may then be removed. Removal of the second bearing 230 may, in turn allow for removal of the wheel assembly 700 from the axle portion 294.

A number of embodiments have been described. Nevertheless, it will be understood that various modifications may be made without departing from the spirit and scope of the specification.

Logic flows depicted in the figures, if any, do not require the particular order shown, or sequential order, to achieve desirable results. In addition, other steps may be provided, or steps may be eliminated, from the described flows, and other components may be added to, or removed from, the described systems.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A brake and wheel assembly, including:
a bogie, including:
a central support member; and
an axle extending outward from the central support member, the axle including a cylindrical outer wall, and an end wall, aligned with the central support member, at an inboard end portion of the cylindrical outer wall, the cylindrical outer wall and the end wall defining an interior space;
a brake assembly installed in the interior space, and accessible via an opening at an outboard end portion of the cylindrical outer wall; and
a wheel assembly installed on an outer peripheral portion of the axle.

2. The brake and wheel assembly of claim 1, wherein the brake assembly includes:
a rotor and stator assembly; and
a rotor cage, including:
a body portion positioned between an outer peripheral portion of the rotor and stator assembly and an inner peripheral portion of the axle; and
a flange portion at an outboard end portion of the body portion and configured to be fixed to a rim of the wheel assembly such that the rotor cage rotates together with the wheel assembly.

3. The brake and wheel assembly of claim 2, wherein the rotor and stator assembly includes:
a plurality of rotors arranged on a carrier; and
a plurality of stators alternately arranged on the carrier with the plurality of rotors,
wherein outer peripheral portions of the plurality of rotors are configured to engage the body portion of the rotor cage such that the plurality of rotors rotate together with the rotor cage and the wheel assembly.

4. The brake and wheel assembly of claim 3, wherein
the carrier is mounted on a mounting rod that is fixed to the end wall of the axle, and
inner peripheral portions of the plurality of stators are engaged with the carrier, such that the plurality of stators remain stationary with the carrier.

5. The brake and wheel assembly of claim 1, wherein the brake assembly extends from the inboard end portion to the outboard end portion of the cylindrical outer wall defining the interior space in the axle.

6. The brake and wheel assembly of claim 1, wherein the wheel assembly includes:
a rim assembly;
a tire coupled to an outer peripheral portion of the rim assembly; and
a first bearing and a second bearing installed between an inner peripheral portion of the rim assembly and an outer peripheral portion of the cylindrical outer wall of the axle.

7. The brake and wheel assembly of claim 6, wherein the first bearing is positioned corresponding to an inboard end portion of the rim assembly, and the second bearing is positioned corresponding to an outboard end portion of the rim assembly.

8. The brake and wheel assembly of claim 6, wherein the rim assembly includes:
a first rim portion;
a second rim portion; and
a fastening ring positioned at an overlap portion between the first rim portion and the second rim portion.

9. The brake and wheel assembly of claim 8, further comprising:
a slot formed in the second rim portion; and
an arm formed on the second rim portion and configured to be slidably received in the slot formed in the second rim portion so as to circumferentially align the first rim portion and the second rim portion.

10. The brake and wheel assembly of claim 9, wherein the overlap portion of the first rim portion and the second rim portion is formed at a position wherein the arm of the first rim portion is inserted into the slot of the second rim portion, and wherein the fastening ring is positioned on an outer circumferential surface of the second rim portion, at a position corresponding to the overlap portion.

11. The brake and wheel assembly of claim 10, wherein the fastening ring includes:
a band having a contour that corresponds to an outer circumferential surface of the second rim portion at a position corresponding to the overlap portion; and
a plurality of threaded openings arranged circumferentially along the band.

12. The brake and wheel assembly of claim 11, further comprising:
a first plurality of openings formed in the first rim portion, at positions corresponding to the plurality of threaded openings of the fastening ring;
a second plurality of openings formed in the second rim portion, at positions corresponding to the first plurality of openings and the plurality of threaded openings; and
a plurality of fasteners extending through the first plurality of openings, the second plurality of openings, and into the plurality of threaded openings formed in the band of the fastening ring to fixedly couple the first rim portion and the second rim portion of the rim assembly.

13. The brake and wheel assembly of claim 8, wherein the wheel assembly includes a hub fan coupled to an outboard end portion of the rim assembly, wherein the hub fan is configured to draw external air into the interior space formed in the axle and across the brake assembly for discharge through openings formed in an inboard end portion of the cylindrical outer wall of the axle.

14. The brake and wheel assembly of claim 1, further comprising a torque attenuation device, including:
a torque bracket having a first end portion thereof coupled to an inboard end portion of a mounting rod fixed to the end wall of the axle; and
a torque rod having a first end portion thereof coupled to a second end portion of the torque bracket, and a second end portion thereof configured to be coupled to a shock absorbing strut of an aircraft landing gear.

15. The brake and wheel assembly of claim 1, wherein the end wall is positioned in the interior space defined by the cylindrical outer wall such that the end wall separates the interior space into a first interior space defining a first axle portion at a first side of the end wall, and a second interior space defining a second axle portion at a second side of the end wall.

16. The brake and wheel assembly of claim 15, wherein
the first axle portion is configured to receive a first brake assembly in the first interior space, and a first wheel assembly mounted on a first portion of the cylindrical outer wall corresponding to the first axle portion; and
the second axle portion is configured to receive a second brake assembly in the second interior space, and a second wheel assembly mounted on a second portion of the cylindrical outer wall corresponding to the second axle portion.

17. A wheel assembly, including:
a rim assembly configured to be mounted on an axle portion of an aircraft landing gear assembly; and
a tire coupled to an outer peripheral portion of the rim assembly,
wherein the rim assembly includes:
a first rim portion;
a second rim portion;
a slot formed in one of the first rim portion or the second rim portion;
an arm formed on the other of the first rim portion or the second rim portion and configured to be slidably received in the slot to circumferentially align the first rim portion and the second rim portion; and
a fastening ring positioned on an outer circumferential surface of the rim assembly, at an overlap portion between the first rim portion and the second rim portion, where the arm is received in the slot.

18. The wheel assembly of claim 17, wherein the fastening ring includes:
a band having a contour that corresponds to the outer circumferential surface of the rim assembly at a position corresponding to the overlap portion; and
a plurality of threaded openings arranged circumferentially along the band.

19. The wheel assembly of claim 18, further comprising:
a first plurality of openings formed in the first rim portion, at positions corresponding to the plurality of threaded openings of the fastening ring;
a second plurality of openings formed in the second rim portion, at positions corresponding to the first plurality of openings and the plurality of threaded openings; and
a plurality of fasteners extending through the first plurality of openings, the second plurality of openings, and into the plurality of threaded openings formed in the band of the fastening ring to fixedly couple the first rim portion and the second rim portion of the rim assembly.

20. The wheel assembly of claim 17, wherein the rim assembly is configured to be mounted on the axle portion of the aircraft landing gear assembly such that a brake assembly installed in the axle portion is removable from an outboard side of the wheel assembly mounted on the axle portion.
